(19) United States
(12) Patent Application Publication
(10) Pub. No.: US 2023/0200569 A1
(43) Pub. Date: Jun. 29, 2023

(54) System and method for adjusting a position of an order taking device

(71) Applicant: Everseen Limited, Blackpool (IE)

(72) Inventors: Ana Cristina Todoran, Arad (RO); Otniel-Bogdan Mercea, Arad (RO); Razvan-Dorel Cioarga, Oradea (RO)

(21) Appl. No.: 17/562,365

(22) Filed: Dec. 27, 2021

(51) Int. Cl. A47F 10/06; G06V 40/16; G06V 20/58; H04N 5/232

(52) U.S. Cl. CPC A47F 10/06; G06V 40/166; G06V 20/58; H04N 5/23219

(57) ABSTRACT

The present disclosure relates to a method for adjusting a position of an order taking device in a drive-through facility. The method includes detecting a stopped vehicle in the drive-through facility, determining a location of a user in the stopped vehicle based on a class and a location of the stopped vehicle, enabling the order taking device to move towards the user location, detecting a human face in a video frame received from a video camera mounted on the order taking device, and enabling the order taking device, to move towards a location of the detected human face.

### FIELD OF THE INVENTION

The present invention relates to a system and a method for adjusting a position of an order taking device in a drive-through facility, and more specifically to a system and method for adjusting a position of the order taking device to adapt to a diversity of shapes and sizes of vehicles entering the drive-through facility.

### BACKGROUND

In the wake of Covid-19, social distancing has become an essential component in the armory to stop the spread of the disease. In customer-facing services, the isolation of customers from other customers and staff members is especially important. For example, while drive-through restaurant lanes have been used for decades as a driver of sales at fast food chains, demand for such facilities has recently increased as pandemic restriction measures have forced the closure of indoor dining restaurants. The drive-through restaurant arrangement uses customer vehicles and their ordered progression along a road to effectively isolate customers from each other. The automation is also increasingly used to further limit physical contacts.

The infrastructure of a typical drive-through facility has a substantially fixed configuration. Specifically, the infrastructure involves customer engagement devices (e.g. microphones, speakers and menu display boards) arranged at fixed locations in the facility and at fixed elevations and orientations relative to service lane(s) for the incoming customer vehicles. However, today's customer vehicles come in a wide variety of shapes and forms. Similarly, individuals vary in the length of their trunk area. Thus, the seated height of individuals may vary considerably. Thus, the fixed positioning of customer engagement devices means that the customer engagement devices are not always positioned to enable most effective engagement with the customer in their vehicle. For example, for higher vehicles, a customer engagement device may be positioned too low for the customer to easily reach. In this case, the customer may have to stretch uncomfortably to reach the customer engagement device.

In view of the above, there is a need to provide a system and method for adjusting a position of the order taking device in a drive-through facility to adapt to a diversity of shapes and sizes of vehicles entering the drive-through facility, thereby providing a better customer experience and satisfaction.

### SUMMARY OF THE INVENTION

In an aspect of the present disclosure, there is provided a method for adjusting a position of an order taking device in a drive-through facility. The method includes detecting a stopped vehicle in the drive-through facility, determining a location of a user in the stopped vehicle based on a class and a location of the stopped vehicle, enabling the order taking device to move towards the user location, detecting a human face in a video frame received from a video camera mounted on the order taking device, and enabling the order taking device, to move towards a location of the detected human face.

In another aspect of the present disclosure, there is provided an apparatus for adjusting a position of an order taking device in a drive-through facility. The apparatus includes a processor communicatively coupled to the order taking device, and configured to: detect a stopped vehicle in the drive-through facility, determine a location of a user in the stopped vehicle based on a class and a location of the stopped vehicle, enable the order taking device to move towards the user location, detect a human face in a video frame received from a video camera mounted on the order taking device, and enable the order taking device, to move towards a location of the detected human face.

In yet another aspect of the present disclosure, there is provided a system that includes an order taking device for taking one or more orders from one or more vehicles in a drive-through facility, a position adjustment device communicatively coupled to the order taking device, for adjusting a position of the order taking device and a vehicle dimensions database. The position adjustment device is configured to detect a stopped vehicle in the drive-through facility, retrieve from the vehicle dimensions database, a vehicle record based on a classification of the stopped vehicle, determine a location of a user in the stopped vehicle based on the retrieved vehicle record and a location of the stopped vehicle, enable the order taking device to move towards the user location, detect a human face in a video frame received from a video camera mounted on the order taking device, and enable the order taking device, to move towards a location of the detected human face.

In yet another aspect of the present disclosure, there is provided a non-transitory computer readable medium configured to store a program causing a computer to adjust a position of an order taking device in a drive-through facility. Said program is configured to detect a stopped vehicle in the drive-through facility, determine a location of a user in the stopped vehicle based on a class and a location of the stopped vehicle, enable the order taking device to move towards the user location, detect a human face in a video frame received from a video camera mounted on the order taking device, and enable the order taking device, to move towards a location of the detected human face.

This summary is provided to introduce a selection of concepts, in a simple manner, which are further described in detailed description of the invention. This summary is neither intended to identify the key or essential inventive concept of the subject matter, nor to determine the scope of the invention.

Further benefits, goals and features of the present invention will be described by the following specification of the attached figures, in which components of the invention are exemplarily illustrated. Components of the devices and method according to the inventions, which match at least essentially with respect to their function, can be marked with the same reference sign, wherein such components do not have to be marked or described in all figures.

The invention is just exemplarily described with respect to the attached figures in the following.

### BRIEF DESCRIPTION OF DRAWINGS

The invention will be described and explained with additional specificity and detail with the accompanying figures in which:

FIG. 1 illustrates a drive through facility, wherein various embodiments of the present invention can be practiced;

FIG. 2 illustrates the drive through facility of FIG. 1 being divided into a plurality of regions to assist with the operations of the position adjustment system, in accordance with an embodiment of the present disclosure;

FIG. 3 illustrates the position adjustment system in detail, in accordance with an embodiment of the present disclosure; and

FIGS. 4A and 4B illustrate a flowchart illustrating a method for adjusting a position of an order taking device, in accordance with an embodiment of the present disclosure.

Furthermore, the figures may show only those specific details that are pertinent to understanding the embodiments of the present invention so as not to obscure the figures with details that will be readily apparent to those skilled in the art having the benefit of the description herein.

### DETAILED DESCRIPTION OF INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

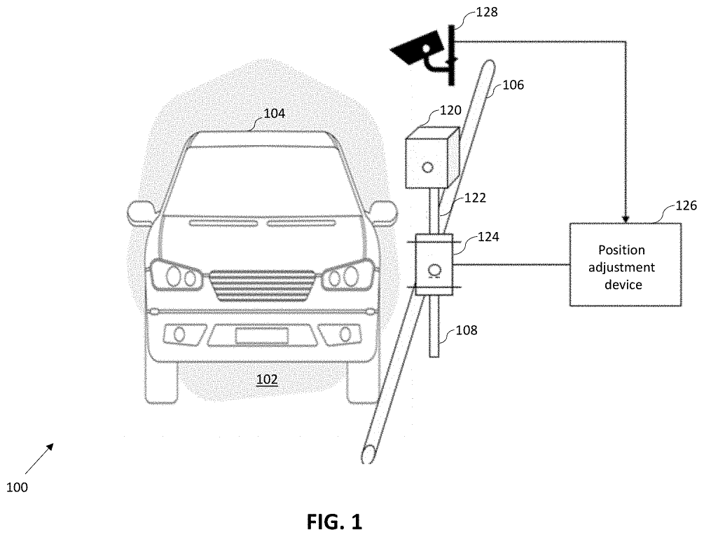

FIG. 1 illustrates a drive-through facility 100, wherein various embodiments of the present invention can be practiced. The drive-through facility 100 includes a service lane 102 for receiving one or more incoming customer vehicles 104. The drive-through facility 100 further includes a rail unit 106 mountable on a plurality of substantially equally spaced upright post members (not shown). The rail unit 106 is installed alongside the service lane 102 and within a pre-defined distance from the service lane 102. The rail unit 106 may include a plurality of markings or other indicators painted on or integrated into the rail unit 106 spaced apart along the length of the rail unit 106. The pre-defined distance depends on a variety of conditions, most notably the layout of the drive-through facility 100. For example, there may be obstructions, including notices, traffic islands, supports for overhead coverings, power/water access points etc. Therefore, depending on the layout of an individual drive through facility, these features might not be movable, in which case, the rail unit 106 needs to move around these features.

The drive-through facility 100 further includes one or more order-taking devices 108 attached to the rail unit 106, wherein the one or more order-taking devices 108 are spaced apart on the rail unit 106 by pre-defined gaps.

However, for the sake of clarity, only one order taking device 108 has been illustrated herein. The order-taking device 108 includes a customer engagement device 120, an elevator unit 122 and a housing unit 124. The customer engagement device 120 is mounted on a first end of the elevator unit 122. The opposite end/ a second end distal the first end of the of the elevator unit 122 is mounted on the housing unit 124. The customer engagement device 120 may include, a display unit (not shown), a microphone (not shown), a speaker (not shown), a card reader unit (not shown) including a contact-based and/or contactless card or a radio frequency reader unit, or a near field communication (NFC) tag reader. The customer engagement device 120 is communicatively coupled with the housing unit 124 and is adaptable to receive a payment from a customer either by a payment card or by any other wireless payment device.

In one embodiment, the elevator unit 122 includes an upright pole member which is telescopically extendable from the housing unit 124. In another embodiment, the elevator unit 122 includes a hingedly coupled first and second arm members (not shown) mountable on an upright pole member (not shown). The customer engagement device 120 is hingedly coupled to a first end of the first arm member and an opposing end of the first arm member is hingedly coupled to a first end of the second arm member, so that the first arm member and the second arm member are arranged in a balanced arm configuration. Further, an opposing end of the second arm member (distal the first end) is mountable on a first end of the upright pole member, and an opposing second end of the upright pole member is pivotably coupled to an upper region of the housing unit 124.

The housing unit 124 is mounted on the rail unit 106. The housing unit in one configuration is slidably engaged with the rail unit 106. A control system is provided for moving the housing unit along the length of the rail unit 106. The housing unit may, for example, include one or more motors such as translation servo motors configured to move the housing unit 124 slidably along the length of the rail unit 106. The control system of housing unit 124 also includes one or more elevation servos (not shown) to activate the elevator unit 122 for adjusting an elevation of the customer engagement device 120. Further, the housing unit 124 includes a sensor to determine a location of the housing unit 124 relative to plurality of the markings present on the rail unit 106. This enables the housing unit 124 to determine how far it has travelled along the rail unit 106 at any given time.

The drive-through facility 100 further includes a position adjustment device 126 communicatively coupled to the housing unit 124 and to a video camera system 128. The video camera system 128 includes one or more cameras to monitor the drive-through facility 100, the movements of customer vehicles 104 and the order-taking devices 108. The video camera system 128 system may include one or more video cameras mounted on the upright pole members of the rail unit 106, video cameras installed at different locations within the drive-through facility 100, and/or video cameras mountable on the housing unit 124 and/or the customer engagement device 120 to capture video footage of the drive-through facility 100 from the perspective of the order-taking device 108 as it moves along the rail unit 106.

In an embodiment of the present disclosure, the video camera system 128 is adapted to capture a video footage of the drive-through facility 100 within a field of view of respective cameras. The video footage includes a plurality of successively captured video frames, where a given video frame Fr(τ+iΔt)ϵ [symbol] ^{n×m} is captured by a video camera at time instant (also known as sampling time) τ+iΔt wherein τ is the time at which capture of the video footage starts and Δt is the time interval (also known as the sampling interval) between successively captured video frames. Using this notation, the video footage VIDϵ [symbol] ^{n×(p×m)} captured by a video camera can be described as

VIDϵ [symbol] ^{n×(p×m)=[Fr(τ),Fr(τ+Δ}t),Fr(τ+2Δt) . . . Fr(τ+pΔt)] (1)

wherein p is the number of video frames in the captured video footage.
Similarly, in the event video footage is captured from a plurality of video cameras of the video camera system 128, individual video frames captured by q>1 video cameras at a given sampling time (τ+iΔt) can be concatenated to form a fused video footage. The fused video footage VIDϵ [symbol] ^{(p×m)×(n×q)} can be described as

VIDϵ [symbol] ^{(p×m)×(n×q)=[[Fr}₀(τ),Fr₁(τ) . . . Fr_{q}(τ)]^{T},[Fr₀(τ+Δt),Fr₁(τ+Δt) . . . Fr_{q}(τ+Δt)]^{T}, . . . ,[Fr₀(τ+pΔt),Fr₁(τ+pΔt) . . . Fr_{q}(τ+pΔt)]^{T}] (2)

Hence, a video frame formed by concatenating a plurality of video frames each of which is captured at the same sampling time (for example, [Fr₀(τ),Fr₁(τ) . . . Fr_{q}(τ)]^{T}) will be referred to henceforth as a “concatenated video frame”. In other words, the fused video footage is formed from a plurality of concatenated video frames. Similarly, individual video frames concatenated within a concatenated video frame will be referred to henceforth as “concatenate members”.

In operation, the order-taking device 108 is mounted on the rail unit 106 and arranged in a manner such that the customer engagement device 120 face out towards the service lane 102. Upon entry of the customer vehicle 104 into the service lane 102, the position adjustment device 126 receives video footage of the drive-through facility 100 from the video camera system 128. The position adjustment device 126 then processes the received video footage and based on the results of the processing, communicates with the translation servos and/or the elevation servos housed within the housing unit 124 to adjust the elevation and horizontal distance of the customer engagement device 120, so that the customer engagement device 120 is moved closer to the customer vehicle 104. In this manner, the order-taking device 108 is moved closer to the customer vehicle 104, thereby making the order taking and payment process more comfortable to a user of the customer vehicle 104.

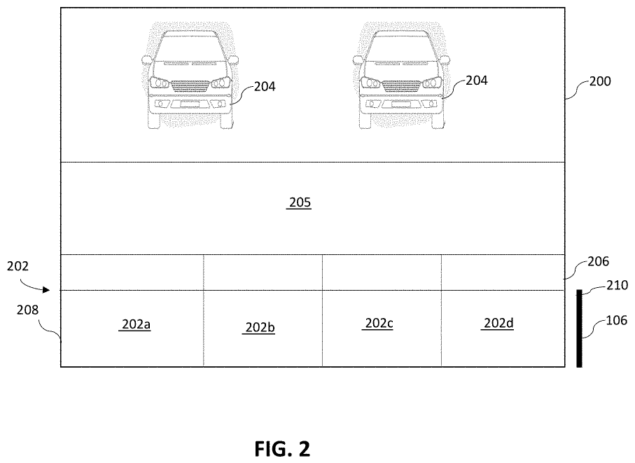

FIG. 2 illustrates the drive-through facility 100 divided into a plurality of regions to assist with the operations of the position adjustment device 126. The plurality of regions include, but not limited to, an entrance region 200 and a service lanes region 202 including a plurality of service lanes 202a, 202b, 202c and 202d. The incoming customer vehicles 204 drive through the entrance region prior to entering a selected service lane in the service lanes region 202. Thus, by monitoring the entrance region 200, an initial estimate may be obtained of volume and movement of traffic in the drive-through facility 100, and distribution of different vehicle types within that traffic.

Also, a drivable region 205 is defined between the entrance region 200 and the service lanes region 202 to provide an understanding of a customer behavior in the drive-through facility 100. The drivable region 205 is defined as a region where a customer selects a service lane into which to drive a customer vehicle. By monitoring a vehicle activity in the drivable region 205, customers may be directed to faster moving or less occupied service lanes based on monitoring and knowledge of current queue lengths and pendency times in individual service lanes (e.g. according to the complexity of orders being undertaken by vehicles in the service lane) drivers, thereby enhancing overall throughput of the drive-through facility 100.

The service lanes region 202 is divided into a pre-order region 206 and a rail segment region 208. The pre-order region 206 is located between the drivable region 205 and the rail unit 106. The end of the rail unit 106 closest to the pre-order region 206 will be referred to henceforth as the rail unit origin 210. The rail segment region 208 is co-terminus with the rail unit 106 and is divided into a plurality of rail segment regions (not shown). The number of rail segment regions is determined by number of customer vehicles that can be queued end to end along the length of the rail unit 106. The locations of the above-mentioned regions of the drive-through facility 100 are first defined according to their co-ordinates in the video frames captured by the video camera system 128 monitoring these regions. Using knowledge of the physical dimensions and layout of the drive-through facility 100 and the locations of the video camera system 128 installed therein, the video frame co-ordinates of the pre-defined regions of the drive-through facility 100 may be mapped to real world coordinates.

Referring to FIGS. 1, 2 and 3, the position adjustment device 126 includes a master controller 302. The master controller 302 is arranged to receive a stream of video. For example, the master controller 302 may be communicatively coupled to the video camera system 128 including one or more video cameras 304a and 304b mounted on the upright pole members of the rail unit 106 and/or installed at different locations within the drive-through facility 100. The position adjustment device 126 further includes a pre-screen unit 306 and an adjustor unit 308, each communicatively coupled to the master controller 302.

The master controller 302 is adapted to choreograph the activities of the pre-screen unit 306 and the adjustor unit 308 to deliver a two-stage process for moving the customer engagement device 120, to bring it closer to the occupants of a customer vehicle 104 to enable more convenient and comfortable usage of the customer engagement device 120 by the occupants of the customer vehicle 104. The master controller 302 also co-ordinate the activities of the sensor unit 312 and the movement unit 314 of the adjustor unit 308.

The master controller 302 receives and fuses video footage from the video camera system 128, and transmits the resulting fused video footage to the pre-screen unit 306 and the adjustor unit 308. The pre-screen unit 306 processes the received fused video frames to detect presence of a customer vehicle 104, for example in a pre-order region. The pre-screen unit 306 further determines stopping of the detected customer vehicle 104, for example in the rail segment region 208 and determines a location of the stopped customer vehicle 104, for example in the pre-order region. The pre-screen unit 306 then sends the processed information to the master controller 302.

The master controller 302 includes one or more conditional logic units (not shown) to activate the adjustor unit 308 based on the information received from the pre-screen unit 306. The conditional logic units generate an activation signal to activate the adjustor unit 308 only upon stopping of those customer vehicles 104 which pass through the pre-order region 206 and stop in the rail segment region 208, or for example, stopped in the vicinity or proximal to the order-taking device 108 This conditional activation helps in eliminating false detections of customer vehicles, thereby preventing unnecessary movements of the order-taking device 108 and respective customer engagement device 120. Also, the conditional activation approach helps in reducing problems caused by identity switching where a customer vehicle at a given sampling instant is mistaken for a different vehicle with similar appearance detected in a previous sampling instant. The absence of the conditional activation approach may cause the order-taking device 108 and their customer engagement device 120 to move unnecessarily between the locations of different customer vehicles rather than remaining in aligned with a single customer vehicle.

The pre-screen unit 306 includes a tracker unit 310 configured to process the fused video footage received from the master controller 302. The tracker unit 310 processes the fused video footage to detect presence of a customer vehicle 104 and to determine a location of the detected customer vehicle 104 in the drive-through facility 100. Therefore, the pre-screen unit 306 is configured to track movements of the customer vehicle 104 in the drive-through facility 100. The movement of the customer vehicle 104 in the pre-order region 206 and stopping of the customer vehicle 104 in the rail segment region 208 is detected by the pre-screen unit 306 and communicated to the master controller 302. Based on the communication by the pre-screen unit 306, the master controller 302 activates the adjustor unit 308 to perform a two-stage movement of the order-taking device 108 to an optimal position for comfortable usage of the customer engagement device 120 by a user of the customer vehicle 104.

The adjustor unit 308 includes a sensor unit 312 for determining a location of the customer engagement device 120 relative to the customer vehicle 104, and a movement unit 314 for using the determined location of the customer engagement device 120 to compute a control signal to cause the customer engagement device 120 to an optimal position for comfortable usage of the customer engagement device 120.

Since the customer engagement device 120 comprises a display unit, a microphone, a speaker, and a card reader unit; an optimal position for comfortable usage of the customer engagement device, is a position which allows the user to see the display easily, speak into the microphone so that their utterances can be heard without the necessity of the user contorting themselves or stretching uncomfortably out of the vehicle window to reach the microphone; hear the sounds from the speaker so that the messages from the speaker are intelligible to the user against the background noise in the drive through facility, without the user having to contorting themselves or stretching uncomfortably out of the vehicle window to reach the speaker; and present their payment card to the card reader without having to get out of their vehicle, contort themselves or otherwise stretch uncomfortably out of the vehicle window to reach the car reader.

The sensor unit 312 includes a vehicle detection unit 316 and a face detection unit 318. The vehicle detection unit 316 is configured to determine a current location of the customer vehicle 104 relative to a location of the rail unit 106. The vehicle detection unit 316 is further configured to determine a rail segment region 208 in which the customer vehicle 104 has stopped upon receiving the activation signal from the master controller 302. Further, the vehicle detection unit 316 classifies the detected customer vehicle 104 in one of a plurality of pre-defined vehicle classifications to determine a location of a driver's window or a front passenger's window of the customer vehicle 104. The plurality of pre-defined classifications include a sedan, an SUV, a truck, a cabrio, a minivan, a minibus, a microbus, a motorcycle, and a bicycle.

The face detection unit 318 detects presence of a human face within a pre-defined distance of the detected location of the driver's window or the front passenger's window based on the classification of the customer vehicle 104. Further, the face detection unit 318 determines a location of the detected human face by employing one or more face detection algorithms

The pre-defined distance of the detected location is the distance at which the face detection unit 318 detects presence of a human face depends on a variety of conditions, most notably the nature of the camera used, the lighting conditions in the drive through facility and the pose of the face (e.g. front facing, side facing etc.) and the extent of occlusion of the face (e.g. if the person is wearing sunglass or a scarf etc.)

The sensor unit 312 includes a tracker unit 320, a vehicle classifier unit 322 and a vehicle dimensions database 324. Similar to the tracker unit 310 of the pre-screen unit 306, the tracker unit 320 of the vehicle detection unit 316 process fused video footage received from the master controller 302, to detect presence of the customer vehicle 104 in the drive-through facility 100, and to determine a location of the detected customer vehicle 104.

It should be noted that the tracker units 310 and 320 may employ same or different tracking algorithms for detecting a customer vehicle and determining a location of the detected customer vehicle, thereby helping in tracking of movements of a customer vehicle in the drive-through facility 100.

Regardless of which tracking algorithm is employed, the output from the tracker units 310 and 320 includes co-ordinates of a bounding box which encloses the detected customer vehicle 104. The bounding box may be referred to henceforth as a vehicle bounding box. The co-ordinates of the vehicle bounding box may be established with respect to a co-ordinate system of the video frame in which the customer vehicle 104 is visible. Using knowledge of physical dimensions of the locations of the video camera system 128 and an identity of a camera which captured the relevant video frame, the tracker units 310 and 320 may translate the co-ordinates of the vehicle bounding box into the real world coordinates.

The tracker units 310 and 320 determine stopping of the detected customer vehicle 104 in the rail segment region 208 when no changes are detected in the location of the customer vehicle 104. In an embodiment, the customer vehicle 104 is determined to have stopped when a difference between vehicle bounding box co-ordinates from successive video frames is less than a pre-defined threshold value for a pre-defined number of such successive video frames. In another embodiment, a moving average value may be calculated of co-ordinates of a centroid of a vehicle bounding box over a pre-defined number of successive video frames. If the moving average value is less than a pre-defined threshold value for a pre-defined number of such successive video frames, then the customer vehicle 104 is deemed to have stopped.

The predefined threshold at which a customer vehicle 104 is determined to have stopped depends on the drive through operator's desired throughput of vehicles. For example, if the drive-through facility is rather cluttered or there are lots of vehicles moving through it at the same time with short distances between the vehicles, the drive through operators might want the vehicles to be at a full stop for 30 seconds or more before moving the customer engagement device to the user's location to avoid the risk of collision caused by distracting vehicle drivers. Alternatively, if there's lots of space in a drive through facility, the risk of a vehicle driver colliding with something might be reduced, because in the event the driver was distracted, they would have enough time to correct their driving to avoid the collision. So, in this case, it might not be necessary for the vehicle to be at a full stop for as long as in the previous example, before moving the customer engagement device to the vehicle.

Further, for detecting movements of customer vehicles in the plurality of regions of the drive-through facility 100, the tracker units 310 and 320 compute an intersection over union (IoU) measurement between real-world co-ordinates of a vehicle bounding box and locations of boundaries of the plurality of regions. The tracker units 310 and 320 further calculate a distance between the rail unit origin 210 and real-world coordinates of the vehicle bounding box when the customer vehicle 104 is detected to be within a pre-defined distance of the pre-order region 206 or the rail segment region 208. This helps to address situations in which the customer vehicle 104 has stopped between the pre-order region 206 and the nearest rail segment region 208, or the customer vehicle 104 has stopped between the adjacent rail segment regions. This also helps to address situations in which the customer vehicle 104 has stopped at a location other than might have been expected based on a detected class of the customer vehicle 104 and other customer vehicles waiting to be served.

The vehicle classifier unit 322 classifies the detected customer vehicle 104 in one of a pre-defined number of classes of vehicles. The vehicle classifier unit 322 employs an object detector algorithm to classify the detected customer vehicle 104 in one of the pre-defined classes of vehicles. Examples of the pre-defined classes of vehicles include, but are not limited to, sedan, SUV, truck, cabrio, minivan, minibus, microbus, motorcycle, and bicycles.

However, the skilled person will understand that the above-mentioned vehicle classes are provided for example purposes only. In particular, the skilled person will understand that the position adjustment device 126 is not limited to the detection of vehicles of the above-mentioned classes. Instead, the position adjustment device 126 is adaptable to detect any class of movable vehicle that is detectable in a video frame.

As illustrated, the vehicle classifier unit 322 is shown to be separate from the tracker unit 310. However, it would be apparent to the vehicle classifier unit 322 can be an integral part of the tracker unit 320 depending on the tracking algorithm implemented by the tracker unit 320. When the vehicle classifier unit 322 is an integral component of the tracker unit 320, the object detector algorithm of the vehicle classifier unit 322 also determines a location of the detected customer vehicle 104 in the received video frame. The location of the detected customer vehicle 104 is represented by co-ordinates of a bounding box which is configured to enclose the detected customer vehicle and the co-ordinates of a bounding box are established with respect to a co-ordinate system of the video frame. Thus, if the vehicle classifier unit 322 is an integral component of the tracker unit 320, the output from the vehicle classifier unit 322 includes the co-ordinates of a vehicle bounding box.

In the context of the present disclosure, the tracker units 310 and 320 employ a tracking algorithm that combines appearance-based matching with position-based matching of historical observations of a vehicle. The appearance-based tracking aspect of this tracking algorithm is based on observed differences in physical appearance attributes of individual classes of vehicle and instances of the same class. Thus, the vehicle classifier unit 322 forms an integral component of this tracking algorithm.

In one embodiment, the object detector algorithm employed by the vehicle classifier unit 322 includes (but not limited to) a deep neural network whose architecture is substantially based on YOLOv4 (as described in A Bochkovskiy, C-Y Wang and H-Y M Liao, 2020 arXiv: 2004.10934) or the EfficientDet (as described in M. Tan, R. Pang and Q. V. Le, EfficientDet: Scalable and Efficient Object Detection, 2020 IEEE/CVF Conference on Computer Vision and Pattern Recognition (CVPR), Seattle, Wash., USA, 2020, pp. 10778-10787). In another embodiment, any object detector network and/or training algorithm which is suitable for detection and classification of a vehicle in an image or video frame may be used by the vehicle classifier unit 322.

The objective of using an object detector algorithm is to cause it to establish an internal representation of a customer vehicle, wherein the internal representation allows the object detector algorithm to recognize a customer vehicle in a received video footage. To meet this objective, a dataset used in the object detector algorithm consists of a video footage of a variety of scenarios recorded in a variety of different drive-through facilities and/or establishments. The video footage, which will henceforth be referred to as the training dataset is assembled with an aim of providing robust, class-balanced information about different vehicles derived from different views of a vehicle obtained from different viewing angles. The training dataset may include, but not limited to, a video footage of a scenario in which one or more vehicles are entering a drive-through facility, one or more vehicles progressing through the drive-through facility, one or more vehicles leaving the drive-through facility, a vehicle parking in a location proximal to the drive-through facility, or a vehicle re-entering the drive-through facility. The members of the training dataset are selected to create sufficient diversity to overcome the challenges posed by variations in illumination conditions, perspective changes, a cluttered background and most importantly intra-class variation. In most instances, images of a given scenario are acquired from multiple cameras, thereby providing multiple viewpoints of the scenario. Therefore, multiple cameras may be set up in a variety of different locations to record the different scenarios in the training dataset to overcome challenges to recognition posed by view-point variation.

The training dataset is created by first processing a video footage to remove video frames/images that are very similar and then adding it to the training dataset. The members of the training dataset may also be subjected to data augmentation techniques to increase diversity, thereby increasing robustness of the eventual trained object detector model. Specifically, the images/video frames may be resized to a standard size wherein the size is selected to balance the advantages of more precise details in the video frame/image against the cost of more computationally expensive network architectures required to process the video frame/image. Similarly, all of the images/video frames are re-scaled to a value in the interval [−1, 1], so that no features of an image/video frame have significantly larger values than the other features. In a further pre-processing step, the individual images/video frames in the video footage of the training dataset are provided with one more bounding boxes, wherein each such bounding box is arranged to enclose a vehicle visible in the image/video frame. The extent of occlusion of the view of a vehicle in an image/video frame is assessed. Those vehicles whose view in an image/video frame is more than 70% un-occluded are labelled with the class of the vehicle. As discussed before, the class label is selected from the set comprising sedan, cabrio, SUV, truck, minivan, minibus, bus, bicycle, motorcycle.

The resulting images may be further pre-processed by resizing, padding, random cropping, random horizontal flipping and normalization. Specifically, the images may be resized to a standard size. Furthermore, parts of individual camera frames may be randomly cropped therefrom to increase the diversity of the dataset. For example, an image of a car may be cropped into several different images, each of which captures different portions (comprising almost all) of the car, and all looking slightly different from each other. This may increase the robustness of the Vehicle Classifier Unit 54 to the diversity of viewed scenarios likely to be encountered in eventual use. Similarly, the images may be subjected to a random erasing operation in which some of the pixels in the image may be automatically erased. This may be useful for simulating occlusion, so that the vehicle classifier unit 322 becomes more robust to occlusion. In horizontal flipping, a vehicle (e.g. a car) in an image is flipped horizontally so that it faces to either the right or the left side of the image. Without horizontal flipping, the vehicles in the images used for training might all face towards the same side of the images, in which case, the vehicle classifier unit 322 could incorrectly learn that a vehicle may always face in a particular direction. In normalization, all of the features in an image may be re-scaled to a value in the interval [−1, 1], so that no feature has significantly bigger values than the other features. Using the above training process, once suitably trained and cross-validated, the vehicle classifier unit 322 may be used for subsequent real-time processing of video footage.

. The vehicle dimensions database 324 includes a plurality of vehicle records, each of which include details of dimensions of at least one aspect of a given class. In an example, a vehicle record may include, but not limited to, an approximate length of a vehicle of a same class, and an approximate length of a front passenger's window calculated as an approximately pre-determined proportion of a length of a vehicle.

Examples of the dimensions include, but are not limited to, a position of a centroid of the front passenger's window, a position of a centroid of the front passenger's window relative to rest of the vehicle, a descriptor of a number of windows or rows of seats in a vehicle (i.e. whether the vehicle is a 2-seater, 4 seater etc.), and/or a plurality of longitudinal, lateral and elevation metrics collectively describing a 3D shape of a vehicle. The metrics include at least one of: a distance from front of a vehicle to its windscreen, a distance from a windscreen to the closest edge of a front-passenger's window of a vehicle, an elevation of a bottom of a front passenger's window at a side closest to a windscreen of a vehicle, and a distance between a top and a bottom of a front passenger's window measured at a side closest to a windscreen of a vehicle. Further, in a case when a vehicle is a bicycle or a motorbike, the vehicle is treated as a plane and the dimensions include but are not limited to a distance between an outer edge of a front wheel of the vehicle and a saddle of the vehicle, and an elevation of the saddle.

The vehicle classifier unit 322 is communicatively coupled to the vehicle dimensions database 324 and is configured to use the determined classification of the customer vehicle 104 to retrieve its corresponding vehicle record from the vehicle dimensions database 324.

In totality, the vehicle detection unit 316 combines the dimensions from the retrieved vehicle record with the detected location of the customer vehicle to establish an estimated location of the driver's window and/or the front passenger's window. For brevity, the estimated location of the driver's window and/or the front passenger's window may be referred to henceforth as the estimated window location. The estimated window location may include the elevation of the driver's window and/or the front passenger's window. In one example, the estimated window location is described by the location of the centroid of the driver's window and/or the location of the centroid of the front passenger's window. The vehicle detection unit 316 transmits the estimated window location to the master controller 302.

The face detection unit 318 receives, from the master controller 302, a fused video footage captured by the video camera system 128. The video frames received from the one or more video cameras mounted on the customer engagement device 120 may be referred to henceforth as customer engagement device (CEU) video frames. The face detection unit 318 employs one or more face detection algorithms to detect presence of a human face in the video footage and to return co-ordinates of a bounding box enclosing the detected human face. A bounding box enclosing a detected human face may be referred to henceforth as a facial bounding box. The co-ordinates of the facial bounding box may be defined with reference to the co-ordinates of the CEU video frames. Since, the CEU video frames are captured from the perspective of the customer engagement device 120, the co-ordinates of the facial bounding box may also be defined with reference to the customer engagement device 120. After, the co-ordinates of the facial bounding box are determined, the face detection unit 318 transmits the co-ordinates of the facial bounding box to the master controller 302.

In one embodiment, the face detection unit 318 uses a deep neural network with a RetinaFace architecture as described in J. Deng, J Guo, E. Ververas, I Kotsia and S Zafeirious, RetinaFace: Single-stage Dense Face Localisation in the Wild, Proceedings of the IEEE/CVF Conference on Computer Vision and Pattern Recognition (CVPR), 2020, pp. 5203-5212; and T.-Y. Lin, P. Goyal, R. Girshick, K. He and P. Dollar, Focal Loss for Dense Object Detection, IEEE Transactions on Pattern Analysis and Machine Learning, 2018, 42(2), 318-327. The RetinaFace network offers an advantage of being able to detect faces in complex scenarios like a drive-through facility and offer improved detection speed, which is an important advantage of use in a real time environment. In another embodiment, the face detection unit 318 may use any object detector network and/or training algorithm which is suitable for detection, classification and localization of a face in an image or video frame or concatenation of the same.

The RetinaFace network is pre-trained on a training set comprising images/video frames acquired from one or more video cameras mounted on the housing unit 124 and/or the customer engagement device 120 of the order-taking device 108. The training set further includes images/video frames acquired from one or more video cameras installed at one or more first locations proximal to premises under observation (e.g. the drive through facility) to increase diversity of the training set, thereby increasing generalization ability of the trained RetinaFace network. Further, the training set is enhanced using data augmentation techniques (such as horizontal flipping) or any other form of data augmentation capable of increasing size and diversity of the training set. For example, the training set may be enhanced using random cropping and photo-metric color distortion. In a further pre-processing step, individual images/video frames of the training set are provided with one more bounding boxes, where each of the bounding boxes is arranged to enclose a face visible in the image/video frame. Similarly, individual images/video frames of the training set are further annotated with positions of five facial landmarks, namely left eye, right eye, left lip, right lip and nose.

In one embodiment, the RetinaFace network is configured to process received CEU video frames to produce a bounding box enclosing the detected human face. The bounding box is represented by co-ordinates of a bottom left-hand corner of the bounding box, a width of the bounding box and a height of the bounding box. In another embodiment, the RetinaFace network is configured to process received CEU video frame) to produce co-ordinates of the five facial landmarks—left eye, right eye, left lip, right lip and nose, and a dense 3D mapping of the facial landmarks. If more than one human face is detected, the face detection unit 318 retains co-ordinates of a largest bounding box and discards remaining co-ordinates. The co-ordinates of the bounding box are used to calculate a centroid of the bounding box, wherein co-ordinates of the centroid are referred to hereinafter as detected facial co-ordinates.

The vehicle detection unit 316 transmits the location of the detected customer vehicle 104 and the face detection unit 318 transmits the co-ordinates of the facial bounding box to the master controller 302. Upon receipt of the location of the detected customer vehicle 104 and/or the co-ordinates of the facial bounding box, the master controller 302 triggers the movement unit 314 to move the customer engagement device 120 to the location of the detected customer vehicle 104 or to the location of the detected human face.

The movement unit 314 includes a position detection unit 326 and a position adjuster unit 328, communicatively coupled to each other. The position detection unit 326 determines a current location of the housing unit 124 on the rail unit 106 based on the markings or other indicators mounted on, painted on or otherwise integrated into the rail unit 106. The position detection unit 326 also determines a current elevation of the customer engagement device 120.

The position adjuster unit 328 receives the current location of the housing unit 124 and the current elevation of the customer engagement device 120 from the position detection unit 326. The position adjuster unit 328 also receives the estimated window location and the location of the detected human face from the master controller 302. Based on the received information, the position adjuster unit 328 calculates a first translation difference between the current location of the housing unit 124 and the estimated window location. The position adjuster unit 328 then computes a first translation control signal from the calculated first translation difference for causing the housing unit 124 to be moved in either direction along the rail unit 106 to bring the housing unit 124 closer to the driver's window or the front passenger's window of the customer vehicle 104.

Further, the position adjuster unit 328 calculates a first elevation difference between the current elevation of the customer engagement device 120 and an elevation component of the estimated window location. The position adjuster unit 328 then computes a first elevation control signal from the calculated first elevation difference for altering the elevation of the customer engagement device 120 to bring it closer to the driver's window or the front passenger's window.

In an example, in the event the customer engagement device 120 is currently positioned at a higher elevation than the centroid of the driver's window and/or the front passenger's window, the first elevation difference has a positive value. In this case, the first elevation control signal is designed to cause the customer engagement device 120 to be moved in a downwards direction towards the centroid of the driver's window and/or the centroid of the front passenger's window. However, on the other hand, in the event, the customer engagement device 120 is currently positioned at a lower elevation than the centroid of the driver's window and/or the centroid of the front passenger's window, the first elevation difference has a negative value. In this case, the first elevation control signal is designed to cause the customer engagement device 120 to be moved in an upwards direction towards the centroid of the driver's window and/or the centroid of the front passenger's window.

Also, the position adjuster unit 328 receives the detected facial co-ordinates from the face detection unit 318 and co-ordinates of centroid of the CEU video frame, from the master controller 302. The position adjuster unit 328 then calculates a second translation difference based on a horizontal distance between the detected facial co-ordinates and the CEU centroid co-ordinates. The position adjuster unit 328 also calculates a second elevation difference based on a vertical distance between the detected facial co-ordinates and the CEU centroid co-ordinates. Thereafter, the position adjuster unit 328 calculates a second translation control signal from the second translation difference for causing the housing unit 124 to be moved in either direction along the rail unit 106 to bring the housing unit 124 closer to the detected customer vehicle 104. The position adjuster unit 328 also calculates a second elevation control signal from the second elevation difference for causing the customer engagement device 120 to be raised or lowered to bring it closer to the detected customer vehicle 104.

In an example, it is assumed that an upper left hand corner of a CEU video frame is denoted by co-ordinates (0,0) and co-ordinates progressing in a rightwards and downwards directions from the upper left hand corner have progressively increasing values. In this case, a positively valued second translation difference indicates that the facial bounding box is offset towards the right-hand side of the CEU video frame. Thus, the second translation control signal causes the housing unit 124 to be moved along the rail unit 106, in a rightwards direction, to cause the detected facial co-ordinates to be aligned with centroid co-ordinates of the CEU video frame. Similarly, a negatively valued second translation difference indicates that the facial bounding box is offset towards the left-hand side of the CEU video frame. Thus, the second translation control signal causes the housing unit 124 to be moved along the rail unit 106, in a leftwards direction, to cause the detected facial co-ordinates to be aligned with centroid co-ordinates of the CEU video frame. Similarly, in the event the customer engagement device 120 is positioned higher than the detected customer vehicle 104, the second elevation distance has a positive value. Thus, the second elevation control signal causes the customer engagement device 120 to be moved in a downwards direction towards the detected human face. On the other hand, if the customer engagement device 120 is positioned lower than the detected customer vehicle 104, the second elevation distance has a negative value. Hence, the second elevation control signal causes the customer engagement device 120 to be moved upwards towards the detected human face.

In further embodiments, the calculations of the first translation control signal, the second translation control signal, the first elevation control signal and the second elevation control signal may employ pre-configured thresholds for first translation difference, second translation difference, first elevation difference and second elevation difference.

Once computed, the position adjuster unit 328 transmits the first translation control signal and the second translational control signal to one or more translation servos of the order-taking device 108 to cause the housing unit 124 to slide along the rail unit 106 towards the location of the detected customer vehicle 104 or perform an alignment with the detected human face of an occupant of the detected customer vehicle 104. The position adjuster unit 328 also transmits the first elevation control signal and the second elevation control signal to one or more elevation servos of the order-taking device 108 to cause the elevation of the customer engagement device 120 to be adjusted as appropriate.

Further, the position adjuster unit 328 can also receive an adjustor signal from the master controller 302 if the position adjuster unit 328 does not receive detected facial co-ordinates and CEU centroid co-ordinates. Upon receiving the adjustor signal, the position adjuster unit 328 issues a pre-configured first and second adjustor control signal to the translation servo and the elevation servo of the order-taking devices 108 to cause the housing unit 124 to slide along the rail unit 106 in a rightwards or a leftwards direction by a pre-configured distance, and to increase or decrease the elevation of the customer engagement device 120 by a pre-configured value. The position adjuster unit 328 repeats these steps until it receives the detected facial co-ordinates and CEU centroid co-ordinates from the master controller 302.

Upon completion of the movement of the customer engagement device 120, the position adjuster unit 328 transmits a triggering signal to the master controller 302 to initiate an engagement, for example, an order-taking process, with the occupants of the detected customer vehicle 104.

Thus, the master controller 302 effects a two-stage movement of the order-taking device 108 and its customer engagement device 120. In a first stage, a coarse estimate of an optimal location for the order-taking device 108 and its customer engagement device 120 is established based on the detected location of the customer vehicle 104 and the estimated location of either or both of the driver's window and the front passenger's window. Alternatively, the coarse estimate may be established by detecting the presence of a human figure within the detected customer vehicle 104 and estimating the location of a centroid of the detected human figure. The order-taking device 108 and its customer engagement device 120 are moved to the coarse estimate location.

Upon receipt of a confirmation signal from the movement unit 314 indicating the completion of the first stage movement, the master controller 302 implements the second stage movement of the order-taking device 108 and its customer engagement device 120. Specifically, in the second stage, video footage from the video camera(s) mounted on the customer engagement device 120 are processed to detect the presence and location of a face of an occupant of the customer vehicle 104. The optimal location for the order-taking device 108 is one which is aligned with the detected location of the face. Specifically, the optimal location for the order-taking device 108 is one in which the detected face is substantially centered in the Field of View of the video camera(s) mounted on the customer engagement device 120. By implementing this gated two-stage approach, the master controller 302 delivers an especially computationally efficient method of searching the drive-through facility 100 to establish the most optimal position for the order-taking device 108 and its customer engagement device 120.

When the master controller 302 fails to receive co-ordinates of a detected face within a pre-defined time interval of the completion of the first stage movement, it is indicative that the movement of the order-taking device 108 and its customer engagement device 120 to the coarse estimate location was not sufficient to enable detection of a face of an occupant of the customer vehicle 104. Thus, in this case, the master controller 302 is adapted to transmit a pre-configured adjustor signal to the position adjuster unit 328 to cause the housing unit 124 to slide along the rail unit 106 in a rightwards or leftwards direction by a pre-configured amount, and to cause the elevation of the customer engagement device 120 to be increased or decreased by a pre-configured amount.

The amount is dependent on the error in the detection and localization of a face and this depends on a variety of factors including the camera, the lighting, the pose of the user, the occlusion of the face, the size of the window and the vehicle; and its presentation relative to the housing unit (e.g. is the vehicle huge with a small window, is the vehicle stopped perfectly in parallel with the housing unit, or is the vehicle at an angle to the housing unit). In other words, the value of the jitter needs to be empirically determined and varies from one situation to the next. But a first instinct would be to make the jitter a percentage of the size and elevation of the vehicle window. For example, if a car side window was between 100 cm and 75 cm width and approximately 50 cm, then the left-right jitter might be approximately 4 cm in either direction and 2.5 cm in either of an up or down direction. But this shouldn't be used as a concrete value for the jitter. The number would really need to be empirically adjusted by the operators.

In an embodiment of the present disclosure, the position adjustment device 126 may be implemented through a processing system that may be communicatively coupled to the video camera system 128. The processing system may represent a computational platform that includes components that may be in a server or another computer system, and execute, by way of a processor (e.g., a single or multiple processors) or other hardware described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The processing system may include a processor that executes software instructions or code stored on a non-transitory computer-readable storage medium to perform method and functions that are consistent with that of the present disclosure. In an example, the processing system may be embodied as a Central Processing Unit (CPU) having one or more Graphics Processing Units (GPUs) executing these software codes.

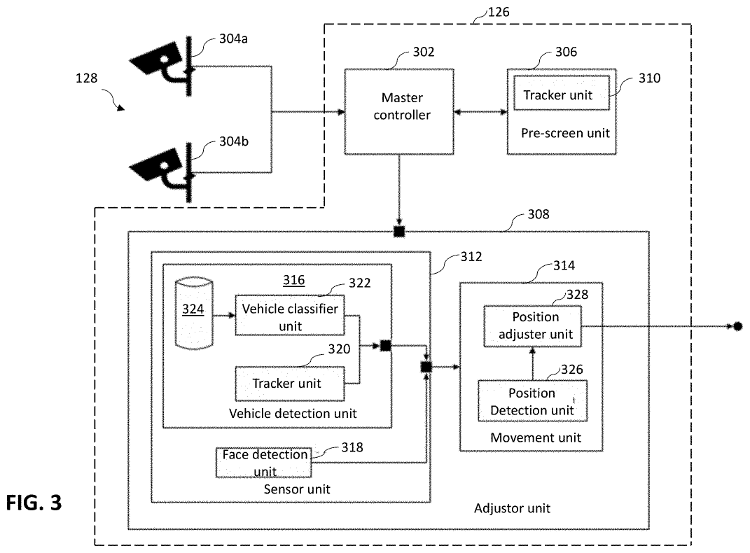

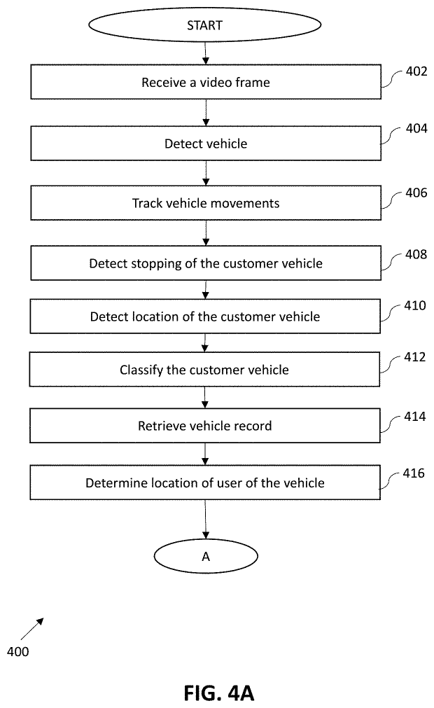

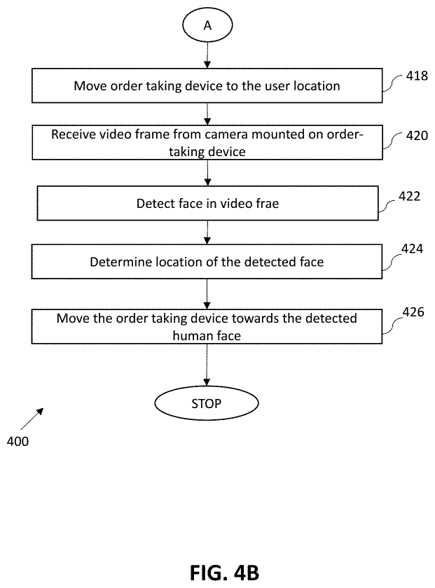

FIGS. 4A and 4B illustrate a flowchart illustrating a method 400 for adjusting a position of an order taking device using the position adjustment system of FIG. 3, in accordance with an embodiment of the present disclosure.

The method 400 illustrates a main processing phase before a set-up phase (not shown) including the steps of pre-training the vehicle classifier unit 322, and the face detection unit 318.

At step 402, a current video frame is received from the video camera system 128. In an embodiment of the present disclosure, the current video frame may include a single frame, or fused one or more video frames. The master controller 302 receives the current video frame from the video camera system 128 and transmits to the pre-screen unit 306 and the adjustor unit 308.

At step 404, a vehicle is detected in the current video frame. At step 406, a movement of the detected vehicle is tracked by comparing the current video frame with one or more previous video frame(s). At step 408, the stopping of the detected vehicle is detected. In an embodiment the step of detecting the stopping of the detected vehicle is preceded by a step of detecting a previous movement of the vehicle through a pre-order region of the drive-through facility. In an embodiment of the present disclosure, the pre-screen unit 306 processes the current video frame to detect presence of a customer vehicle in the pre-order region, determines stopping of the detected vehicle in a rail segment region, and determines a location of the stopped customer vehicle in the pre-order region. The pre-screen unit 306 then sends the processed information to the master controller 302, which receives the processed information and activates the adjustor unit 308.

At step 410, the location of the stopped vehicle is determined. In an embodiment of the present disclosure, the step of determining the location of the stopped vehicle includes the step of determining the location of the stopped vehicle with reference to an origin 210 of the rail unit. At step 412, the stopped vehicle is classified as being one of a sedan, SUV, truck, cabrio, minivan, minibus, microbus, a motorcycle, and a bicycle. In an embodiment of the present disclosure, upon receiving an activation signal from the master controller 302, the vehicle detection unit 316 determines a current location of the detected customer vehicle relative to the rail unit and determines a rail segment region in which the customer vehicle has stopped. Further, the vehicle detection unit 316 classifies the detected customer vehicle based on one or more pre-defined vehicle classifications.

At step 414, a vehicle record corresponding to the classification of the stopped vehicle is retrieved from the vehicle dimensions database 324. At step 416, a location of a user in the detected vehicle is determined based on the location of the vehicle and the retrieved vehicle record. In an embodiment of the present disclosure, the vehicle detection unit 316 combines dimensions present in a vehicle record corresponding to the classification of detected vehicle and a location of the customer vehicle to establish an estimated location of the user of the detected vehicle. Thereafter, the vehicle detection unit 316 sends co-ordinates of a vehicle bounding box enclosing the detected customer vehicle and estimated user location to the master controller 302.

In an embodiment of the present disclosure, the location of the user in the detected vehicle is determined based on a location of a window (driver or passenger's window) of the detected vehicle, when the detected vehicle is four-wheeler. In another embodiment of the present disclosure, the location of the user in the detected vehicle is determined based on a distance between an outer edge of a front tire and a saddle of the vehicle, and an elevation of the saddle, when the detected vehicle is a 2-wheeler.

At step 418, the order-taking device 108 is moved to the user location. In an embodiment of the present disclosure, the order taking device includes a customer engagement device including at least one of: a display unit, a microphone, a speaker, and a card reader unit, a housing unit communicatively coupled to the customer engagement device, an elevator unit in a telescopic arrangement with the housing unit, wherein the customer engagement device is mountable on a first end of the elevator unit, and another end of the elevator unit is mountable on the housing unit. The housing unit includes one or more translation servos to move the housing unit horizontally along the rail unit, one or more elevation servos to adjust an elevation of the customer engagement device, and a sensor to determine a location of the housing unit with respect to the rail unit.

In an embodiment of the present disclosure, the moving of the order taking device to the user location comprises calculating a first translation difference between a current location of the housing unit and the user location in the detected vehicle, calculating a first translation control signal based on the first translation difference, transmitting the first translation control signal to the one or more translation servos to slide the housing unit along the rail unit, to the user location, calculating a first elevation difference between a current elevation of the customer engagement device and an elevation component of the user location, calculating a first elevation control signal from the first elevation difference, and transmitting the first elevation control signal to the one or more elevation servos to adjust an elevation of the customer engagement device based on an elevation of the user in the detected vehicle.

At step 420, a video frame from a video camera mounted on the order-taking device is received by the face detection unit 318 of the adjustor unit 308. At step 422, the presence of a human face is detected in the video frame. In an embodiment of the present disclosure, the step of detecting the presence of a human face comprises the steps of attempting to detect the presence of a human face in the video frame, and in the event of failure, repeatedly performing the steps of moving the order-taking device 108 in a rightwards or leftwards direction by a pre-configured amount and attempting to detect the presence of a human face in the video frame until a human face is detected.

At step 424, the location of the centroid of the detected human face is determined. In an embodiment of the present disclosure, the face detection unit 318 receives Customer engagement device (CEU) video frames captured by one or more video cameras mounted on the order-taking device 108 from the master controller 302. The face detection unit 318 detects presence of a human face in the fused CEU video frames and determines co-ordinates of a facial bounding box enclosing a detected human face. Thereafter, the face detection unit 318 transmits the co-ordinates of the facial bounding box to the master controller 302. In an embodiment of the present disclosure, the master controller 302 triggers the movement unit 314 upon receipt of the location of the detected customer vehicle and/or the co-ordinates of the facial bounding box. Thereafter, the position detection unit 326 determines a current location of the order-taking device 108 on the rail unit, and determines a current elevation of the customer engagement device of the order-taking device 108.

At step 426, the order-taking device 108 is moved to the location of the detected human face, so that the center of the Field of View of the video camera(s) mounted on the customer engagement device 120 are substantially aligned with the centroid of the detected human face. In an embodiment of the present disclosure, the moving the order taking device to the location of the detected human face comprises calculating a second translation difference based on a horizontal distance between facial co-ordinates of the detected human face, and co-ordinates of a centroid of the customer engagement device, calculating a second translation control signal based on the second translation difference, transmitting the second translation control signal to the one or more translation servos to slide the housing unit along the rail unit, towards the detected human face, calculating a second elevation difference based on a vertical distance between the facial co-ordinates of the detected human face, and the co-ordinates of the centroid of the customer engagement device, calculating a second elevation control signal based on the second elevation difference, and transmitting the second elevation control signal to move the customer engagement device in a vertical direction, to align the field of view of the video camera mounted on the customer engagement device with the centroid of the detected human face.

While specific language has been used to describe the invention, any limitations arising on account of the same are not intended. As would be apparent to a person skilled in the art, various working modifications may be made to the method in order to implement the inventive concept as taught herein.

The figures and the foregoing description give example of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A method for adjusting a position of an order taking device in a drive-through facility, the method comprising:
detecting a stopped vehicle in the drive-through facility;
determining a location of a user in the stopped vehicle based on a class and a location of the stopped vehicle;
enabling the order taking device to move towards the user location;
detecting a human face in a video frame received from a video camera mounted on the order taking device; and
enabling the order taking device, to move towards a location of the detected human face.

2. The method of claim 1 further comprising:
enabling the order taking device to move horizontally in leftward and rightward directions along a rail unit by a pre-defined horizontal distance, and vertically in upward and downward directions by a pre-defined vertical distance, till the human face is detected in the video frame from the video camera mounted on the order taking device.

3. The method of claim 1 further comprising classifying the stopped vehicle in one of a plurality of pre-defined classes including: a four wheeler class including a sedan, an SUV, a truck, a cabrio, a minivan, a minibus, and a microbus, and a two-wheeler class including a motorcycle and a bicycle.

4. The method of claim 3 further comprising:
determining the location of the user in the stopped vehicle by determining a location of at least one of: a user window of the stopped vehicle and a driver window of the stopped vehicle, when the stopped vehicle is classified in the four wheeler class.

5. The method of claim 3 further comprising:
determining the location of the user in the stopped vehicle based on a distance between an outer edge of a front tire and a saddle of the vehicle, and an elevation of the saddle, when the stopped vehicle is classified in the two-wheeler class.

6. The method of claim 1 further comprising:
calculating a first translation difference between a current location of the order taking device and the user location in the stopped vehicle;
calculating a first translation control signal based on the first translation difference;
enabling the order taking device to slide along a rail unit, towards the user location based on the first translation control signal;
calculating a first elevation difference between a current elevation of a customer engagement device of the order taking device, and an elevation component of the user location;
calculating a first elevation control signal from the first elevation difference; and
enabling adjusting an elevation of the customer engagement device based on the first elevation control signal towards an elevation of the user in the stopped vehicle.

7. The method of claim 6 further comprising:
calculating a second translation difference based on a horizontal distance between facial co-ordinates of the detected human face, and co-ordinates of a centroid of a customer engagement device;
calculating a second translation control signal based on the second translation difference;
enabling the order taking device to slide along the rail unit, towards the detected human face based on the second translation control signal;
calculating a second elevation difference based on a vertical distance between the facial co-ordinates of the detected human face, and the co-ordinates of the centroid of the customer engagement device;
calculating a second elevation control signal based on the second elevation difference; and
enabling the customer engagement device to move in a vertical direction towards a location of the detected human face, so as to align a field of view of the video camera mounted on the customer engagement device with the centroid of the detected human face.

8. An apparatus for adjusting a position of an order taking device in a drive-through facility, comprising:
a processor communicatively coupled to the order taking device, and configured to:
detect a stopped vehicle in the drive-through facility;
determine a location of a user in the stopped vehicle based on a class and a location of the stopped vehicle;
enable the order taking device to move towards the user location;
detect a human face in a video frame received from a video camera mounted on the order taking device; and
enable the order taking device, to move towards a location of the detected human face.

9. The apparatus of claim 8, wherein the processor is further configured to:
enable the order taking device to move horizontally in leftward and rightward directions along a rail unit by a pre-defined horizontal distance, and vertically in upward and downward directions by a pre-defined vertical distance, till the human face is detected in the video frame from the video camera mounted on the order taking device.

10. The apparatus of claim 8, wherein the processor is further configured to classify the stopped vehicle in one of: a four wheeler class including a sedan, SUV, truck, cabrio, minivan, minibus, and a microbus, and a two-wheeler class including a motorcycle and a bicycle.

11. The apparatus of claim 10, wherein when the stopped vehicle is classified in the four wheeler class, the processor is configured to:
determine the location of the user in the stopped vehicle by determining a location of at least one of: a user window of the stopped vehicle and a driver window of the stopped vehicle.

12. The apparatus of claim 10, wherein when the stopped vehicle is classified in the two-wheeler class, the processor is configured to:
determine the location of the user in the stopped vehicle based on a distance between an outer edge of a front tire and a saddle of the vehicle, and an elevation of the saddle.

13. The apparatus of claim 8, wherein the processor is further configured to:
calculate a first translation difference between a current location of the order taking device and the user location in the stopped vehicle;
calculate a first translation control signal based on the first translation difference;
enable the order taking device to slide along a rail unit, towards the user location based on the first translation control signal;
calculate a first elevation difference between a current elevation of a customer engagement device of the order taking device, and an elevation component of the user location;
calculate a first elevation control signal from the first elevation difference; and
enable adjusting an elevation of the customer engagement device based on the first elevation control signal towards an elevation of the user in the stopped vehicle.

14. The apparatus of claim 13, wherein the processor is further configured to:
calculate a second translation difference based on a horizontal distance between facial co-ordinates of the detected human face, and co-ordinates of a centroid of a customer engagement device;
calculate a second translation control signal based on the second translation difference;
enable the order taking device to slide along the rail unit, towards the detected human face based on the second translation control signal;
calculate a second elevation difference based on a vertical distance between the facial co-ordinates of the detected human face, and the co-ordinates of the centroid of the customer engagement device;
calculate a second elevation control signal based on the second elevation difference; and
enable the customer engagement device to move in a vertical direction towards a location of the detected human face, so as to align a field of view of the video camera mounted on the customer engagement device with the centroid of the detected human face.

15. A system comprising:
an order taking device for taking one or more orders from one or more vehicles in a drive-through facility;
a position adjustment device communicatively coupled to the order taking device, for adjusting a position of the order taking device;
a vehicle dimensions database,
wherein the position adjustment device is configured to:
detect a stopped vehicle in the drive-through facility;
retrieve from the vehicle dimensions database, a vehicle record based on a classification of the stopped vehicle;
determine a location of a user in the stopped vehicle based on the retrieved vehicle record and a location of the stopped vehicle;
enable the order taking device to move towards the user location;
detect a human face in a video frame received from a video camera mounted on the order taking device; and
enable the order taking device, to move towards a location of the detected human face.

16. The system of claim 15 further comprising:
a rail unit extending along a length of the drive-through facility, wherein the order taking device is slidably movable along the rail unit,
wherein the position adjustment device configured to determine a location of the stopped vehicle with reference to an origin of the rail unit.

17. The system of claim 16, wherein the position adjustment device is further configured to:
move the order taking device horizontally in leftward and rightward directions along the rail unit by a pre-defined horizontal distance, and vertically in upward and downward directions by a pre-defined vertical distance, till the human face is detected in the video frame.

18. The system of claim 17, wherein the order taking device comprises:
a customer engagement device including at least one of: a display unit, a microphone, a speaker, and a card reader unit, and wherein the video camera for detecting the human face is mounted on the customer engagement device;
a housing unit communicatively coupled to the customer engagement device; and
an elevator unit in a telescopic arrangement with the housing unit, wherein the customer engagement device is mountable on a first end of the elevator unit, and another end of the elevator unit is mountable on the housing unit,
wherein the housing unit includes one or more translation servos to move the housing unit horizontally along the rail unit, one or more elevation servos to adjust an elevation of the customer engagement device, and a sensor to determine a location of the housing unit with respect to the rail unit.

19. The system of claim 15, wherein the vehicle dimensions database comprises a plurality of vehicle records, each including one or more dimensions, an approximate length, and an approximate length of a window of a user of vehicle corresponding to vehicle class.
